(19) United States
(12) Patent Application Publication
(10) Pub. No.: US 2010/0283177 A1
(43) Pub. Date: Nov. 11, 2010

(54) PROCESS FOR PRODUCING PRECURSOR FILM FOR RETARDATION FILM MADE OF POLYPROPYLENE RESIN

(76) Inventors: Hiroaki Takahata, Ichihara-shi (JP); Yoshinori Takahashi, Ichihara-shi (JP); Kyoko Hino, Nerima-ku (JP); Yoshiaki Ishigami, Ota-ku (JP); Shuji Ozaki, Suminoe-ku (JP); Shuji Fujioka, Suminoe-ku (JP)

Correspondence Address: SUGHRUE MION, PLLC, 2100 PENNSYLVANIA AVENUE, N.W., SUITE 800, WASHINGTON, DC, 20037, US

(21) Appl. No.: 12/679,079

(22) PCT Filed: Sep. 18, 2008
(86) PCT No.: PCT/JP2008/066864

§ 371 Date: Jul. 28, 2010

(30) Foreign Application Priority Data
Sep. 21, 2007 (JP) 2007-245722

(51) Int. Cl. B29C 47/52

(52) U.S. Cl. 264/210.1

(57) ABSTRACT

There is provided a process for producing a precursor film for a polypropylene-based resin retardation film that can yield films with almost no orientation and with high transparency.

The process for producing a precursor film for a polypropylene-based resin retardation film comprises a step of pressing a molten sheet formed by extruding a molten polypropylene-based resin from a T-shaped die 12 at 180° C. or higher and 300° C. or lower between a cooling roll 16 having a surface temperature regulated to −5° C. or higher and 30° C. or lower and a touch roll 14 having a surface temperature regulated to 80° C. or higher and 150° C. or lower, whereby the molten sheet is cooled and solidified.

### TECHNICAL FIELD

The present invention relates to a process for producing a precursor film for a retardation film made of a polypropylene-based resin.

### BACKGROUND ART

Optical films, such as retardation films and polarizer protective films, that are used as structural members in liquid crystal displays (liquid crystal panels) are required to exhibit high optical homogeneity for the improvement in contrast and view angles.

A retardation film is produced by stretching a non-oriented precursor film for a retardation film so that the molecules may be oriented in the same direction and to the same degree. Controlling the orientation axis and the degree of orientation results in the formation of a retardation film which has uniformity of a desired phase difference. Non-stretched precursor films for retardation films are therefore required to be free of such defects as fisheyes, hard spots, or streaks called “die lines” in the films themselves, have high transparency, have minimal thickness deviation and be non-oriented.

Processes for producing cyclic olefin-based resin films are known in the art, wherein the discharge slit (lip) of a T-shaped die is plated with a special material capable of achieving a peel strength of not greater than 75N for molten cyclic olefin resins (molten resins) and the molten resin discharged from the T-shaped die into a film shape is pressed between a casting roll set to have a temperature of (the glass transition temperature Tg of the cyclic olefin resin−30° C.) or higher and not higher than (the glass transition temperature Tg of the cyclic olefin resin+30° C.) and a touch roll set to have a temperature of (the temperature of the casting roll−50° C.) or higher and not higher than the temperature of the casting roll, whereby the molten resin is cooled and solidified (see Patent Document 1, for example).

### [Patent Document 1] Japanese Unexamined Patent Application Publication No. 2000-280315

### DISCLOSURE OF THE INVENTION

### Problems to be Solved by the Invention

In the process described in cited document 1, however, the surface temperature of the casting roll which is in contact with the molten resin for a long time is higher than the surface temperature of the touch roll which is in contact with the molten resin for a very short time. Therefore, there has been a problem that the transparency of a produced film is impaired especially when a polypropylene-based resin is used.

Hence, it is an object of the present invention to provide a process for producing a precursor film for a polypropylene-based resin retardation film from which films with almost no orientation and high transparency can be obtained.

### Means for Solving the Problems

The process for producing a precursor film for a polypropylene-based resin retardation film according to the present invention comprises a step of pressing a molten sheet formed by extruding a molten polypropylene-based resin from a T-shaped die at 180° C. or higher and 300° C. or lower between a cooling roll having a surface temperature regulated to −5° C. or higher and 30° C. or lower and an elastically deformable metal roll having a surface temperature regulated to 80° C. or higher and 150° C. or lower, whereby the molten sheet is cooled and solidified.

In the process for producing a precursor film for a polypropylene-based resin retardation film according to the present invention, the molten resin formed into a film is pressed by the cooling roll and the elastically deformable metal roll. Thus, since both surfaces of the molten resin that has been formed into a film is cooled by the cooling roll (casting roll) and the elastically deformable metal roll (touch roll), it is possible to cool and solidify the molten resin rapidly. As a result, it becomes possible to cool and solidify the molten resin before crystals grow, and therefore it becomes possible to produce a highly transparent precursor film for a polypropylene-based resin retardation film.

Also, the process for producing a precursor film for a polypropylene-based resin retardation film according to the present invention employs a cooling roll and an elastically deformable metal roll. A resin mass (bank) is therefore greatly inhibited from being formed during pressing of the molten resin that has been formed into a film. As a result, orientation hardly occurs and it is possible to produce a precursor film for a polypropylene-based resin retardation film, the precursor film having low phase difference and almost no phase difference irregularities in the width direction.

In addition, in the process for producing a precursor film for a polypropylene-based resin retardation film according to the present invention, a molten sheet is pressed by a cooling roll having a surface temperature regulated to −5° C. or higher and 30° C. or lower and an elastically deformable metal roll having a surface temperature regulated to 80° C. or higher and 150° C. or lower. That is, the surface temperature of the elastically deformable metal roll is set to be a higher temperature than the surface temperature of the cooling roll. The molten sheet is therefore easily released from the elastically deformable metal roll and defects such as wrinkles do not form in the film, resulting in a good film with a mirror surface. If the surface temperature of the cooling roll is lower than −5° C., moisture in the air will condense easily on the cooling roll and, therefore, traces of condensed moisture will be transferred onto the film to prevent a surface condition from becoming a mirror surface, and the quality tends to become defective. If the surface temperature of the cooling roll is higher than 30° C., the transparency of a resulting film will tend to lower. Therefore, both the cases are undesirable. It is also undesirable for the surface temperature of the elastically deformable metal roll to be below 80° C. or higher than 150° C. because the molten sheet will be less easily releasable from the elastically deformable metal roll and defects such as wrinkles will tend to be formed in a film.

Preferably, fluid channels are provided inside the metal roll and the cooling roll, and in the step of cooling solidification, the flow rate of the liquid flowing through the fluid channels is regulated so that the temperature difference between the inlet temperature where the liquid in the fluid channels enters the metal roll and the cooling roll and the outlet temperature where the liquid in the fluid channels exits the metal roll and the cooling roll may be 2° C. or less. This makes it possible to obtain a precursor film for a polypropylene-based resin retardation film, the precursor film being small in thickness deviation and having uniform transparency across the entire surface.

Preferably, in the step of cooling solidification, the length from the discharge slit of the T-shaped die to the point where the molten sheet is pressed by the metal roll and the cooling roll is set to 50 mm or more and 250 mm or less. If the length H of a distance from the discharge slit of the T-shaped die to the point where the melt sheet is pressed by the metal roll and cooling roll (a so-called “air-gap”) is greater than 250 mm, there is a tendency that orientation takes place in the air-gap, so that the phase difference of the raw film for a retardation film made of a polypropylene-based resin [thermoplastic resin film] becomes larger. The lower limit of the air-gap length naturally is approximately 50 mm because this depends on the size of the T-shaped die and the diameters of the metal roll and the cooling roll.

### EFFECT OF THE INVENTION

According to the present invention, it is possible to provide a process for producing a precursor film for a polypropylene-based resin retardation film from which films with almost no orientation and high transparency can be obtained.

### BRIEF DESCRIPTION OF THE DRAWINGS

FIG. 1 is a block diagram showing an overview of a film production system according to an embodiment of the present invention.

FIG. 2 is a table showing the conditions for Examples 1 to 6 and the evaluation results for the same.

FIG. 3 is a table showing the conditions for Comparative Examples 1 to 3 and the evaluation results for the same.

### EXPLANATION OF SYMBOLS

1: Film production system, 12: T-shaped die, 12a: discharge slit, 14: touch roll (elastically deformable metal roll), 14a: metal inner cylinder, 14b: thin metal outer cylinder, 16, 18: cooling rolls, F: raw film for retardation film made of polypropylene-based resin, L: liquid.

### BEST MODE FOR CARRYING OUT THE INVENTION

Preferred embodiments of the present invention will now be explained with reference to the accompanying drawings. Throughout the explanation, identical or similarly functioning elements will be referred to by like reference numerals and will be explained only once.

(Configuration of Film Production System)

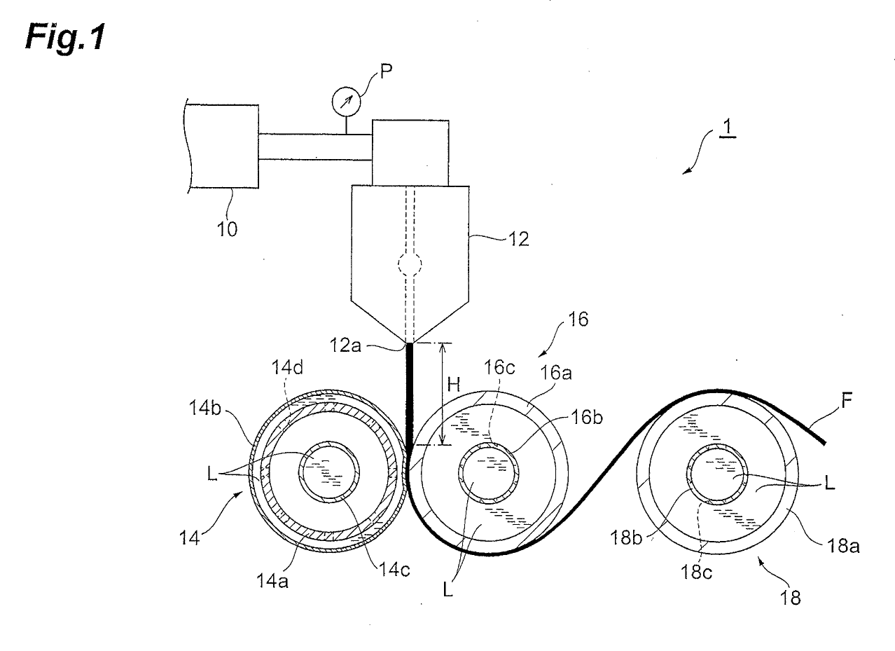

The configuration of a film production system 1 to be used for the process for producing a precursor film for a retardation film made of a polypropylene-based resin according to this embodiment will be explained first, with reference to FIG. 1. The film production system 1 comprises an extruder 10, a T-shaped die 12, a touch roll (elastically deformable metal roll) 14 and cooling rolls 16, 18.

The extruder 10 melts and kneads the loaded polypropylene-based resin while extruding it, and transports the melted and kneaded polypropylene-based resin (molten resin) to the T-shaped die 12.

The T-shaped die 12 is connected to the extruder 10, and it internally has a manifold (not shown) that spreads the molten resin transported from the extruder 10 in the transverse direction. At the bottom section of the T-shaped die 12 there is provided a discharge slit 12a that is in communication with the manifold and discharges the molten resin that has been spread in the transverse direction by the manifold. The molten resin discharged from the discharge slit 12a of the T-shaped die 12 is thus formed into a film form.

The T-shaped die 12 is preferably one without minute level differences or nicks on the wall faces of the molten resin fluid channels. The discharge slit 12a section (lip section) of the T-shaped die 12 is preferably made of a material with a low frictional coefficient with the molten resin (the melted thermoplastic resin), and plated or coated with a hard material (such as a tungsten carbide-based or fluorine-based special plating) because this will allow the radius of curvature of the tip section of the discharge slit 12a to be reduced (the tip section of the discharge slit 12a can be formed as a sharp edge).

The tip section of the discharge slit 12a of the T-shaped die 12 preferably has a sharp edge shape wherein the radius of curvature at the discharge slit 12a located in the wall face of the molten resin fluid channels is not greater than 0.3 mm. Using such a T-shaped die 12 can inhibit T-shaped die drool at the discharge slit 12a while also having an effect of preventing die lines, thus resulting in superior uniformity of appearance for the produced precursor film F for a polypropylene-based resin retardation film.

The length H of a distance from the molten resin discharge slit 12a of the T-shaped die 12 to the point where the molten resin is pressed by the touch roll 14 and cooling roll 16 (a so-called “air-gap”) is preferably about 50 mm to about 250 mm and more preferably about 50 mm to about 180 mm. If the air-gap length H is greater than 250 mm, there is a tendency that orientation takes place in the air-gap, so that the phase difference of the precursor film F for a polypropylene-based resin retardation film becomes larger. The lower limit of the air-gap length H naturally is approximately 50 mm, though this will depend on the film production system 1 including the size of the T-shaped die 12 and the diameters of the touch roll 14 and the cooling roll 16, 18.

The touch roll 14 is equivalent to the presser roll described in Japanese Unexamined Patent Application Publication No. 11-235747, for example. Specifically, the touch roll 14 comprises a highly rigid metal inner cylinder 14a, a thin metal outer cylinder 14b disposed outside the metal inner cylinder 14a, a fluid axis cylinder 14c disposed inside the metal inner cylinder 14a, a liquid L filling the space between the metal inner cylinder 14a and the thin metal outer cylinder 14b and the interior of the fluid axis cylinder 14c, and temperature adjusting means (not shown) for adjustment of the temperature of the liquid L.

The metal inner cylinder 14a, thin metal outer cylinder 14b and fluid axis cylinder 14c are disposed in a coaxial manner. A plurality of through-holes 14d are formed in the metal inner cylinder 14a along its circumference. The liquid L is allowed to circulate inside the touch roll 14, between the fluid axis cylinder 14c, through-holes 14d, and the space between the metal inner cylinder 14a and thin metal outer cylinder 14b, in that order.

The thin metal outer cylinder 14b is formed of stainless steel or the like, and it is flexible with no seam on its surface. In order for the thin metal outer cylinder 14b to have softness, flexibility and recoverability approaching rubber elasticity, its thickness is in the range described by elastodynamic thin cylinder theory. The thin metal outer cylinder 14b used may have a thickness of about 2000 μm to about 5000 μm, a diameter of about 200 mm to about 500 mm and a surface roughness of up to 0.5 S, preferably with a surface roughness of not greater than 0.2 S. If the thickness of the thin metal outer cylinder 14b is less than 2000 μm, the pressure will tend to be insufficient during pressing of the molten resin by the touch roll 14 and cooling roll 16, while if it exceeds 5000 μm the elasticity of the thin metal outer cylinder 14b (touch roll 14) will be too great, such that a resin mass (bank) of the resin will tend to occur during pressing of the molten resin, depending on the size of the thickness of the molten resin discharged from the discharge slit 12a of the T-shaped die 12.

As a liquid L, for example, water, ethylene glycol or oil, may be used. Adjustment of the temperature of the liquid L by the temperature adjusting means (not shown) indirectly adjusts the surface temperature of the thin metal outer cylinder 14b.

The cooling roll 16 comprises a highly rigid metal outer cylinder 16a, a fluid axis cylinder 16b disposed inside the metal outer cylinder 16a, a liquid L filling the space between the metal outer cylinder 16a and the fluid axis cylinder 16b and the interior of the fluid axis cylinder 16b, and temperature adjusting means (not shown) for adjusting the temperature of the liquid L. The cooling roll 18 comprises a highly rigid metal outer cylinder 18a, a fluid axis cylinder 18b disposed inside the metal outer cylinder 18a, a liquid L filling the space between the metal outer cylinder 18a and the fluid axis cylinder 18b and the interior of the fluid axis cylinder 18b, and temperature adjusting means (not shown) for adjusting the temperature of the liquid L. The cooling rolls 16, 18 may have diameters of about 200 mm to about 800 mm and mirror surfaces with a surface roughness of not greater than 0.2 S.

In the cooling rolls 16, 18, the temperature of the liquid L is adjusted by the temperature adjusting means (not shown) like in the touch roll 14, and thereby the surface temperatures of the metal outer cylinders 16a, 18a are indirectly adjusted and the molten resin film discharged from the discharge slit 12a of the T-shaped die 12 is cooled and solidified thereby with the touch roll 14. In order to obtain a precursor film F for a polypropylene-based resin retardation film having low thickness deviation and uniform transparency across its entire surface, the temperature difference between the inlet temperature where the liquid L enters each roll 14, 16, 18 and the outlet temperature where the liquid L exits each roll 14, 16, 18, for the touch roll 14 and cooling rolls 16, 18, is preferably not greater than 2° C. The flow rate of the liquid L is appropriately selected for this purpose. Generally speaking, a greater flow rate of the liquid L will produce a smaller temperature difference between the inlet temperature and outlet temperature. Also, in order to obtain a precursor film F for a polypropylene-based resin retardation film having low thickness deviation in the direction of flow, it is preferred to use a planetary roller reduction device or planetary gear reduction device for the touch roll 14 and cooling rolls 16, 18.

Solidification of the molten resin film by the touch roll 14 and cooling rolls 16, 18 forms a precursor film F for a polypropylene-based resin retardation film. The precursor film F for a polypropylene-based resin retardation film is subsequently subjected to stretching treatment to form a polypropylene-based resin retardation film.

The processing speed for the precursor film F for a polypropylene-based resin retardation film increases with more rapid cooling and solidification of the molten resin, or in other words, with increasing diameter of the cooling roll 16 used as the casting roll.

Specifically, with a cooling roll 16 diameter of 600 mm, the processing speed for the precursor film F for a polypropylene-based resin retardation film can be set to a maximum of about 50 m/min, and normally about 30 m/min.

The touch roll 14 and cooling rolls 16, 18 will usually be arranged in a row below the T-shaped die 12. Specifically, the touch roll 14 and cooling roll 16 are disposed at a prescribed spacing, and the thickness of the precursor film F for a polypropylene-based resin retardation film will depend on the spacing between the touch roll 14 and cooling roll 16, or on the rotational speeds of each roll 14, 16, 18 and the throughput of the molten resin discharged from the discharge slit 12a of the T-shaped die 12.

(Polypropylene-Based Resin)

The polypropylene-based resin used for production of the precursor film F for a polypropylene-based resin retardation film according to this embodiment may be propylene homopolymer, or a copolymer of propylene with one or more monomers selected from the group consisting of ethylene and α-olefins including 4-20 carbon atoms. Blends of the foregoing may also be used.

Specific α-olefins include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 1-octene, 2-ethyl-1-hexene, 3,3-dimethyl-1-hexene, 2-propyl-1-heptene, 2-methyl-3-ethyl-1-heptene, 2,3,4-trimethyl-1-pentene, 2-propyl-1-pentene, 2,3-diethyl-1-butene, 1-nonene, 1-decene, 1-undecene, 1-dodecene, 1-tridecene, 1-tetradecene, 1-pentadecene, 1-hexadecene, 1-heptadecene, 1-octadecene and 1-nonadecene, preferred among which are α-olefins including 4-12 carbon atoms, examples including 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 1-octene, 2-ethyl-1-hexene, 3,3-dimethyl-1-hexene, 2-propyl-1-heptene, 2-methyl-3-ethyl-1-heptene, 2,3,4-trimethyl-1-pentene, 2-propyl-1-pentene, 2,3-diethyl-1-butene, 1-nonene, 1-decene, 1-undecene and 1-dodecene. From the viewpoint of copolymerizability, 1-butene, 1-pentene, 1-hexene and 1-octene are preferred and 1-butene and 1-hexene are more preferred.

Examples of propylene-based copolymers for the present invention include propylene-ethylene copolymer, propylene-α-olefin copolymer and propylene-ethylene-α-olefin copolymer. More specifically, examples of propylene-α-olefin copolymers include propylene-1-butene copolymer, propylene-1-pentene copolymer, propylene-1-hexene copolymer and propylene-1-octene copolymer, and examples of propylene-ethylene-α-olefin copolymers include propylene-ethylene-1-butene copolymer, propylene-ethylene-1-hexene copolymer and propylene-ethylene-1-octene copolymer. Preferred propylene-based copolymers for the present invention are propylene-ethylene copolymer, propylene-1-butene copolymer, propylene-1-pentene copolymer, propylene-1-hexene copolymer, propylene-1-octene copolymer, propylene-ethylene-1-butene copolymer and propylene-ethylene-1-hexene copolymer, with propylene-ethylene copolymer, propylene-1-butene copolymer, propylene-1-hexene copolymer, propylene-ethylene-1-butene copolymer and propylene-ethylene-1-hexene copolymer being more preferred.

When the propylene-based copolymer used for the present invention is a copolymer, the content of the comonomer-derived structural unit in the copolymer is preferably greater than 0 wt % and not greater than 40 wt % from the viewpoint of balance between transparency and heat resistance. From the same viewpoint, it is more preferably greater than 0 wt % and 30 wt %. In the case of a copolymer of two or more comonomers with propylene, the total of all the comonomer structural units in the copolymer is preferably within the range specified above.

The process for producing the propylene-based copolymer for the present invention may be a process of homopolymerization of propylene using a known polymerization catalyst, or a process of copolymerization of propylene with one or more monomers selected from the group consisting of ethylene and α-olefins including 4-20 carbon atoms. Examples of known polymerization catalysts include (1) Ti—Mg catalysts composed of solid catalyst components comprising magnesium, titanium and halogens as essential components, (2) catalyst systems that are combinations of solid catalyst components comprising magnesium, titanium and halogens as essential components, with organic aluminum compounds and if necessary third components such as electron-releasing compounds, and (3) metallocene-based catalysts.

Among these, catalyst systems used for production of propylene-based copolymers according to the present invention are most commonly catalyst systems that are combinations of organic aluminum compounds and electron-releasing compounds with solid catalyst components comprising magnesium, titanium and halogens as essential components. More specifically, preferred organic aluminum compounds include triethylaluminum, triisobutylaluminum, mixtures of triethylaluminum and diethylaluminum chloride, and tetraethyldialuminoxane, while preferred electron-releasing compounds include cyclohexylethyldimethoxysilane, tert-butyl-n-propyldimethoxysilane, tert-butylethyldimethoxysilane and dicyclopentyldimethoxysilane. Examples of solid catalyst components comprising magnesium, titanium and halogens as essential components include the catalyst systems described in Japanese Unexamined Patent Application Publication Nos. 61-218606, 61-287904 and 7-216017. Examples of metallocene catalysts include the catalyst systems described in Japanese Patent Nos. 2587251, 2627669 and 2668732.

The polymerization process used for production of a propylene-based copolymer according to the present invention may be solvent polymerization using an inactive solvent which is typically a hydrocarbon compound such as hexane, heptane, octane, decane, cyclohexane, methylcyclohexane, benzene, toluene or xylene, bulk polymerization using a liquid monomer as the solvent or vapor-phase polymerization carried out in a gaseous monomer, but bulk polymerization and vapor-phase polymerization are preferred because they facilitate post-treatment. These polymerization processes may be either batch processes or continuous processes.

The tacticity of the propylene-based copolymer according to the present invention may be isotactic, syndiotactic or atactic. The propylene-based copolymer used for the present invention is preferably a syndiotactic or isotactic propylene-based copolymer from the viewpoint of heat resistance.

(Additives)

The propylene-based copolymer used for this embodiment may contain known additives in ranges that do not interfere with the effect of the present invention.

Examples of additives include antioxidants, ultraviolet absorption materials, antistatic agents, lubricants, nucleating agents, anti-fogging agents, and anti-blocking agents, among which any two or more may also be used in combination.

Antioxidants include phenol-based antioxidants, phosphorus-based antioxidants, sulfur-based antioxidants, hindered amine-based antioxidants (HALS), and compound antioxidants having, for example, a unit with a phenol-based and phosphorus-based antioxidant mechanism in the molecule.

Ultraviolet absorbers include ultraviolet absorbers such as 2-hydroxybenzophenone-based and hydroxytriazole-based compounds, and ultraviolet blockers such as benzoate-based compounds.

Antistatic agents include polymer, oligomer and monomer agents.

Lubricants include higher fatty acid amides such as erucic acid amide and oleic acid amide, higher fatty acids such as stearic acid, and metal salts of the foregoing.

Examples of nucleating agents include sorbitol-based nucleating agents, organic phosphoric acid salt-based nucleating agents, and polymer-based nucleating agents such as polyvinylcycloalkane. An anti-blocking agent may be used as spherical or nearly spherical fine particles, whether inorganic or organic.

(Molecular Weight)

The melt flow rate (MFR) of the propylene-based copolymer used for this embodiment is the value measured in accordance with JIS K 7210, with a temperature of 230° C. and a load of 21.18N, and it is normally about 0.1 g/10 min to about 200 g/10 min and preferably about 0.5 g/10 min to about 50 g/10 min. Using a propylene-based copolymer with an MFR in this range will allow a uniform film to be formed without large load on the extruder 10.

(Molecular Weight Distribution)

The molecular weight distribution of the propylene-based copolymer used for this embodiment will normally be 1 to 20. The molecular weight distribution is the ratio of Mw to Mn (=Mw/Mn), as calculated with measurement using 140° C. o-dichlorobenzene as the solvent and polystyrene as the reference sample.

(Process for Producing Precursor Film for Polypropylene-Based Resin Retardation Film)

A process for producing a precursor film F for a polypropylene-based resin retardation film by the film production system 1 described above will now be explained with reference to FIG. 1.

First, the polypropylene-based resin is loaded into the extruder 10 through a hopper (not shown) (melting step). In order to inhibit deterioration of the resin, it is preferred to carry out pre-drying in nitrogen at a temperature of 40° C. or higher and not higher than (Tm−20° C.) for about 1 to about 10 hours before supplying the polypropylene-based resin to the extruder 10 (where Tm [° C.] is the melting peak temperature in differential scanning calorimetry in accordance with JIS K 7121, which is determined from the inflection point of the DSC curve obtained using a differential scanning calorimeter (DSC) or the like, with the sample first heated to above the melting point and then cooled at the prescribed rate to about −30° C. (for PP (polypropylene)), with measurement conducted while subsequently raising the temperature at the prescribed rate). The gas in the extruder 10 is also preferably replaced with an inert gas such as nitrogen gas or argon gas at 20° C. to 120° C. If a more constant extrusion output is required, it is effective to employ a gear pump. When impurities or contaminants are a problem, a filter unit such as a leaf disk filter may be used as necessary.

Next, the thermoplastic resin is melted and kneaded with the screw in the cylinder of the extruder 10 that has been heated to a temperature of 180° C. or higher and 300° C. or lower, and the molten resin formed into a film is thus discharged from the discharge slit 12a of the T-shaped die 12 at 180° C. or higher and 300° C. or lower (molding step). The temperature of the molten resin is measured using a resin thermometer at the discharge slit 12a of the T-shaped die 12.

A molten resin temperature of below 180° C. will tend to result in insufficient spreadability of the resin, leading to thickness irregularities caused by uneven elongation in the air-gap. A molten resin temperature of above 300° C. will tend to degrade the resin, and contaminate the lip section because of generation of decomposition gas and cause die lines, resulting in outer appearance defects in the film. For this reason, the molten resin temperature is preferably 220° C. or higher and 280° C. or lower.

In order to obtain a precursor film F for a polypropylene-based resin retardation film with low thickness deviation in the direction of flow, it is particularly preferred to provide a resin pressure gauge P upstream from the inlet of the T-shaped die 12 (see FIG. 1), for regulation so that fluctuation in the pressure of the molten resin flowing near the inlet of the T-shaped die 12 may be not greater than ±0.1 MPa (a difference of not greater than 0.2 MPa between the maximum and minimum pressure of the molten resin).

Next, the molten resin formed into a film is pressed by the touch roll 14 and cooling roll 16 while being cooled and solidified by the touch roll 14 and cooling rolls 16, 18, to obtain a precursor film F for a polypropylene-based resin retardation film (cooling step). The surface temperature of the cooling roll 16 T1[° C.] is set so as to satisfy the condition represented by the following formula (1), while the surface temperature of the thin metal outer cylinder 14b of the touch roll 14 T2[° C.] is set so as to satisfy the condition represented by the following formula (2).

−5° C.−T1≦30° C. (1)

80° C.≦T2≦150° C. (2)

If T1 is lower than −5° C., moisture in the air will condense easily on the cooling roll 16 and, therefore, traces of condensed moisture will be transferred onto the film to prevent a surface condition from becoming a mirror surface, and the quality tends to become defective. If T1 is higher than 30° C., the transparency of a resulting film will tend to lower. Therefore, both the cases are undesirable. It is also undesirable for T2 to be below 80° C. or higher than 150° C. because the molten sheet will be less easily releasable from the touch roll 14 (the elastically deformable metal roll) and defects such as wrinkles will tend to be formed in a film. More preferably, the surface temperature of the cooling roll 16 T1[° C.] is set so as to satisfy the condition represented by the following formula (3), while the surface temperature of the thin metal outer cylinder 14b of the touch roll 14 T2[° C.] is set so as to satisfy the condition represented by the following formula (4).

−5° C.≦T1≦15° C. (3)

100° C.≦T2≦130° C. (4)

The pressing pressure (linear pressure) depends on the pressure with which the touch roll 14 is pressed against the cooling roll 16, and it is preferably about 0.5 N/mm to about 20 N/mm and more preferably about 1 N/mm to about 10 N/mm. If the linear pressure is less than 0.5 N/mm it will tend to be difficult to uniformly control the linear pressure on the molten resin. If the linear pressure is greater than 20 N/mm, the molten resin will be pressed too strongly and as a result the molten resin will form a bank as it collects on the pressed (nip) section, tending to cause significant phase difference to be exhibited.

Common methods for controlling the pressing pressure (linear pressure) include (1) a method of placing a triangular wedge-shaped “filler block”, known as a cotter, at the pressing (nip) section, and adjusting the cotter to modify the roll spacing, or (2) pressing both the touch roll 14 and cooling roll 16 against a cotter adjusted to a prescribed pressure using oil pressure, air or the like. Instead of using a cotter, the rotational speed of the screw may be controlled for mechanical contact bonding to a prescribed point without level differences, or a servomotor may be used in an oil pressure system.

The precursor film F for a polypropylene-based resin retardation film is then taken up with a winder, with slitting (cutting) of the tab section if necessary. Either before or after slitting (cutting) of the tab section of the precursor film F for a polypropylene-based resin retardation film, a protective film may be laminated on one or both sides of the precursor film F for a polypropylene-based resin retardation film.

From the viewpoint of most effectively exhibiting the effect of the present invention, the thickness of the precursor film F for a polypropylene-based resin retardation film is preferably about 70 μm to about 500 μm, although this range is not restrictive. That is, the thickness of the precursor film F for a polypropylene-based resin retardation film may be selected among thicknesses obtained by stretching under different stretching conditions, as required for retardation films for a wide variety of purposes. The stretching method may be longitudinal stretching, transverse stretching, sequential biaxial stretching or simultaneous biaxial stretching. For sequential biaxial stretching, transverse stretching may be carried out after longitudinal stretching, or longitudinal stretching may be carried out after transverse stretching.

The optical film made of a precursor film F for a polypropylene-based resin retardation film produced by the steps described above, having its phase difference controlled by stretching, can be utilized as a retardation film for use in liquid crystal panels with a wide range of sizes, for television sets, personal computer monitors, car navigation systems, digital cameras, cellular phones and the like. Furthermore, because it is non-oriented and highly transparent it can also be used as a polarizing plate protective film, as well as for various types of liquid crystal members.

Incidentally, it is a requirement that precursor films for retardation films is required to be non-oriented. “Non-oriented” means a disordered state without any orientation of the molecular chains of the polymer in the material of the thermoplastic resin. The degree of orientation can be evaluated on the basis of the phase difference value, and the phase difference value can be measured using a commercially available phase difference meter. The phase difference value for a precursor film for the retardation film is preferably about 0 nm to about 50 nm with a thickness of 100 μm. If the phase difference value of the precursor film for the retardation film is outside of this range, it will be difficult to control the phase difference when the precursor film for the retardation film is stretched into a retardation film, even if the stretching conditions are modified, because of the initial phase difference of the precursor film for the retardation film, and this will tend to result in phase difference irregularities and impairment of display uniformity when it is incorporated into a liquid crystal panel, and hence lower product value.

In the embodiment described above, the molten resin that has been formed into a film is pressed between the metal cooling roll 16 and the touch roll 14. Thus, since the surface of the molten resin that has been formed into a film is cooled by the touch roll 14 and the cooling roll 16 (casting roll), it is possible to cool and solidify the molten resin rapidly. As a result, even with a crystalline polypropylene-based resin, it becomes possible to cool and solidify the molten resin before crystals grow, and therefore it becomes possible to produce a highly transparent precursor film F for a polypropylene-based resin retardation film.

Also, this embodiment employs a metal cooling roll 16 and a touch roll 14 having an elastically deformable thin metal outer cylinder 14b. A resin mass (bank) is therefore greatly inhibited from being formed during pressing of the molten resin that has been formed into a film. As a result, orientation hardly occurs and it is possible to produce a precursor film F for a polypropylene-based resin retardation film, which has low phase difference, and has almost no phase difference irregularities in the width direction. The effect of the present invention is exhibited most prominently when using a polypropylene-based resin because it is highly susceptible to loss of optical homogeneity and is approximately 100 times more easily oriented than a cyclic olefin resin.

In addition, the thin metal outer cylinder 14ba of the touch roll 14 and the cooling roll 16 of this embodiment are both made of metal. It is therefore possible to form a precursor film F for a polypropylene-based resin retardation film having excellent surface gloss.

### Example 1

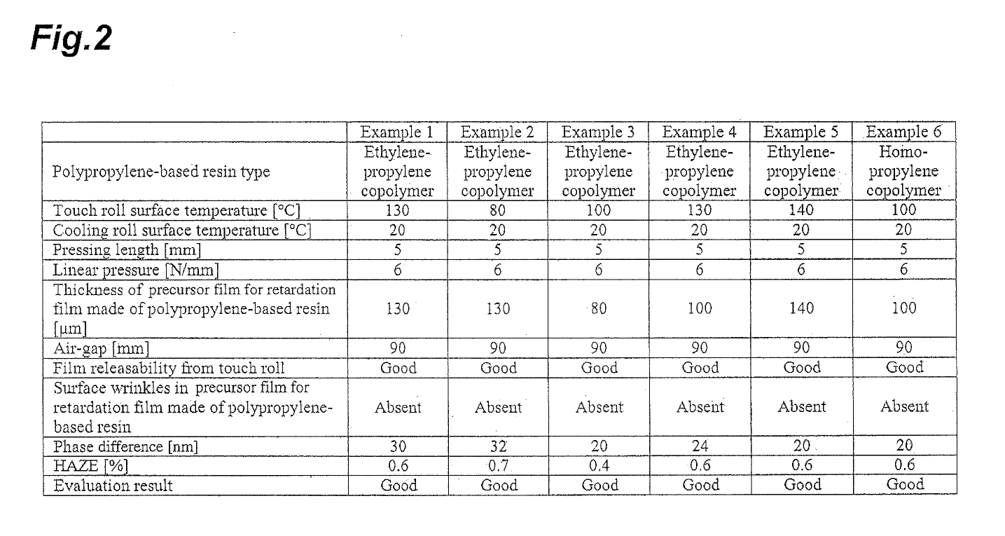

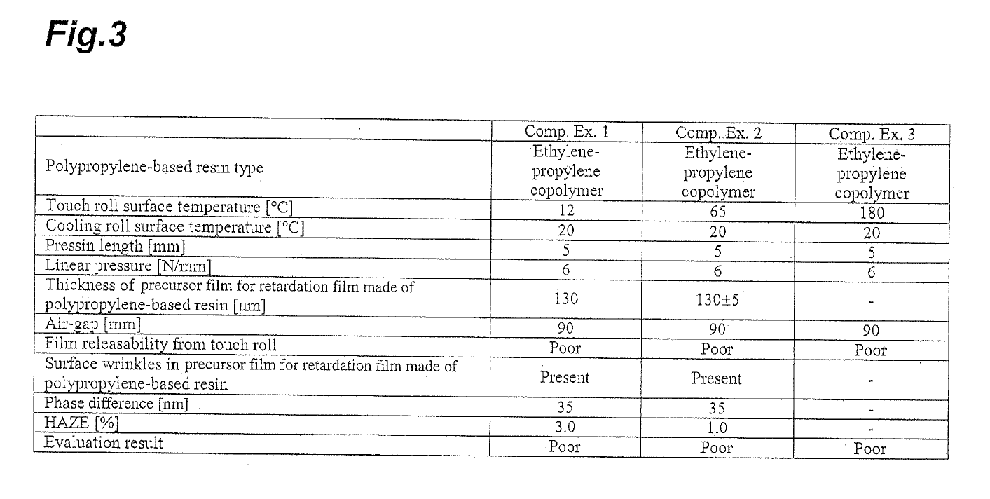

The present invention will now be explained in greater detail based on Example 1, Comparative Examples 1 and 2, and FIGS. 1 to 3, with the understanding that these examples are in no way limitative on the present invention.

### Example 1

An ethylene-propylene-based copolymer (ethylene content=5 wt %, Tm (melting point)=134° C., MFR (melt flow rate)=8 g/10 min) was melted and kneaded with a 90 mmφ extruder 10 (screw: L/D=32) heated to 250° C. and then fed from the extruder 10 to an adapter and T-shaped die 12 (both set to 250° C.) installed after the extruder 10, in that order, and a molten ethylene-propylene-based copolymer resin film (molten resin) was discharged from the discharge slit (lip opening) 12a of the T-shaped die 12. The temperature of the molten resin at the discharge slit 12a section of the T-shaped die 12 was 250° C. The molten resin film was pressed by the touch roll 14 and cooling roll 16 shown in FIG. 1 with a pressing length of 5 mm and a linear pressure of 6 N/mm while being cooled and solidified by the touch roll 14 and cooling rolls 16, 18, to obtain a precursor film F for a polypropylene-based resin retardation film having a thickness of 130 μm.

The thin metal outer cylinder 14b of the touch roll 14 had a diameter of 300 mm, a thickness of 3000 μm and a surface roughness of 0.1 S-0.2 S. The cooling rolls 16, 18 each had a diameter of 350 mm, a surface roughness of 0.1 S and a mirror surface. The rotational speed of the touch roll 14 was set to 9.8 m/min, the rotational speed of the cooling rolls 16, 18 was set to 10.7 m/min, the air-gap H was set to 90 mm, the surface temperature T1 of the cooling roll 16 was set to 20° C., and the surface temperature T2 of the thin metal outer cylinder 14b of the touch roll 14 was set to 130° C.

### Example 2

A precursor film F for a polypropylene-based resin retardation film for Example 2 was obtained in the same manner as Example 1, except that the surface temperature T2 of the thin metal outer cylinder 14b of the touch roll 14 was set to 80° C.

### Example 3

A precursor film F for a polypropylene-based resin retardation film for Example 3 (thickness: 80 μm) was obtained in the same manner as Example 1, except that the surface temperature T2 of the thin metal outer cylinder 14b of the touch roll 14 was set to 100° C., the rotational speed of the touch roll 14 was set to 15.9 m/min and the rotational speeds of the cooling rolls 16, 18 were both set to 17.4 m/min.

### Example 4

A precursor film F for a polypropylene-based resin retardation film for Example 4 (thickness: 100 μm) was obtained in the same manner as Example 1, except that the rotational speed of the touch roll 14 was set to 12.7 m/min and the rotational speeds of the cooling rolls 16, 18 were both set to 13.9 m/min.

### Example 5

A precursor film F for a polypropylene-based resin retardation film for Example 5 (thickness: 140 μm) was obtained in the same manner as Example 1, except that the surface temperature T2 of the thin metal outer cylinder 14b of the touch roll 14 was set to 140° C., the rotational speed of the touch roll 14 was set to 9.1 m/min and the rotational speeds of the cooling rolls 16, 18 were both set to 9.9 m/min.

### Example 6

A precursor film F for a polypropylene-based resin retardation film for Example 6 (thickness: 100 μm) was obtained in the same manner as Example 1, except that a homopropylene-based copolymer (ethylene-propylene copolymer, ethylene content=≦0.2 wt %) was used, the surface temperature T2 of the thin metal outer cylinder 14b of the touch roll 14 was set to 100° C., the rotational speed of the touch roll 14 was set to 12.7 m/min and the rotational speeds of the cooling rolls 16, 18 were both set to 13.9 m/min.

### Comparative Example 1

A precursor film F for a polypropylene-based resin retardation film was obtained for Comparative Example 1 in the same manner as Example 1, except that the surface temperature T2 of the thin metal outer cylinder 14b of the touch roll 14 was set to 12° C.

### Comparative Example 2

A precursor film F for a polypropylene-based resin retardation film was obtained for Comparative Example 2 in the same manner as Example 1, except that the surface temperature T2 of the thin metal outer cylinder 14b of the touch roll 14 was set to 65° C.

### Comparative Example 3

For Comparative Example 3, the same procedure was followed as in Example 1, except that the surface temperature T2 of the thin metal outer cylinder 14b of the touch roll 14 was set to 180° C.

(Evaluation Results)

During production of the precursor film F for a polypropylene-based resin retardation film in each of Examples 1 to 6, the precursor film F for a polypropylene-based resin retardation film released cleanly from the touch roll 14 and the molding stability was satisfactory. Also, upon visual observation of the precursor film F for a polypropylene-based resin retardation film obtained in each of Examples 1 to 6, no wrinkles were found in the surface of the precursor film F for a polypropylene-based resin retardation film, indicating a satisfactory surface condition. When the precursor film F for a polypropylene-based resin retardation film obtained in each of Examples 1 to 6 was cut to 40 mm×40 mm and the phase difference thereof measured with a KOBRA-WPR by Oji Scientific Instruments Co., Ltd., the phase differences were found to be 30 nm, 32 nm, 20 nm, 24 nm, 20 nm and 20 nm, respectively, which were all sufficiently small values of not greater than 32 nm. Further, when the precursor film F for a polypropylene-based resin retardation film obtained in each of Examples 1 to 6 was cut to 50 mm×50 mm and the haze measured according to JIS K 7136 using a haze meter by Suga Test Instruments Co., Ltd., the values were 0.6%, 0.7%, 0.4%, 0.6%, 0.6% and 0.6% respectively, which were all 0.7% or lower indicating excellent transparency. The haze is an index of the film transparency, and a smaller value indicates higher transparency. Thus, the quality of each precursor film F for a polypropylene-based resin retardation film obtained in Examples 1 to 6 was evaluated as “G: Good”.

On the other hand, during production of the precursor film F for a polypropylene-based resin retardation film in Comparative Example 1, the precursor film F for a polypropylene-based resin retardation film exhibited poor releasability from the touch roll 14, and its molding stability was unsatisfactory. Upon visual observation of the precursor film F for a polypropylene-based resin retardation film obtained in Comparative Example 1, wrinkles were found in the surface of the precursor film F for a polypropylene-based resin retardation film, indicating an unsatisfactory surface condition. When the precursor film F for a polypropylene-based resin retardation film obtained in Comparative Example 1 was cut to 40 mm×40 mm and the phase difference thereof measured with a KOBRA-WPR by Oji Scientific Instruments Co., Ltd., the phase difference was found to be 35 nm, which was a larger value compared to Examples 1 to 6. Also, the haze of the precursor film F for a polypropylene-based resin retardation film obtained in Comparative Example 1 measured according to JIS K 7136 was 3.0%, which indicated poor transparency compared to Examples 1 to 6. Thus, the quality of the precursor film F for a polypropylene-based resin retardation film obtained in Comparative Example 1 was evaluated as “P: Poor”.

During production of the precursor film F for a polypropylene-based resin retardation film in Comparative Example 2, the precursor film F for a polypropylene-based resin retardation film exhibited even poorer film releasability from the touch roll 14 than Comparative Example 1 and release marks remained in the film, while its molding stability was highly unsatisfactory. Upon visual observation of the precursor film F for a polypropylene-based resin retardation film obtained in Comparative Example 2, wrinkles were found in the surface of the precursor film F for a polypropylene-based resin retardation film, indicating an unsatisfactory surface condition. Due to the poor surface condition of the film, thickness irregularities were present in the precursor film F for a polypropylene-based resin retardation film obtained in Comparative Example 2, with a large thickness irregularity of 130±5 μm in the widthwise direction of the film. When the precursor film F for a polypropylene-based resin retardation film obtained in Comparative Example 2 was cut to 40 mm×40 mm and the phase difference thereof measured with a KOBRA-WPR by Oji Scientific Instruments Co., Ltd., the phase difference was found to be 35 nm, which was a larger value compared to Examples 1 to 6. Also, the haze of the precursor film F for a polypropylene-based resin retardation film obtained in Comparative Example 2 measured according to JIS K 7136 was 1.0%, which indicated poor transparency compared to Examples 1 to 6. Thus, the quality of the precursor film F for a polypropylene-based resin retardation film obtained in Comparative Example 2 was evaluated as “P: Poor”.

When it was attempted to produce a precursor film F for a polypropylene-based resin retardation film in Comparative Example 3, the molten resin adhered around the touch roll 14 during molding, making it impossible to obtain a precursor film F for a polypropylene-based resin retardation film.

1. A process for producing a precursor film for a polypropylene-based resin retardation film, comprising a step of pressing a molten sheet formed by extruding a molten polypropylene-based resin from a T-shaped die at 180° C. or higher and 300° C. or lower between a cooling roll having a surface temperature regulated to −5° C. or higher and 30° C. or lower and an elastically deformable metal roll having a surface temperature regulated to 80° C. or higher and 150° C. or lower, whereby the molten sheet is cooled and solidified.

2. The process for producing a precursor film for a polypropylene-based resin retardation film according to claim 1,
wherein fluid channels are provided inside the metal roll and the cooling roll, and
wherein in the step of cooling solidification, the flow rate of the liquid flowing through the fluid channels is regulated so that the temperature difference between the inlet temperature where the liquid in the fluid channels enters the metal roll and the cooling roll and the outlet temperature where the liquid in the fluid channels exits the metal roll and the cooling roll may be 2° C. or less.

3. The process for producing a precursor film for a polypropylene-based resin retardation film according to claim 1, wherein in the step of cooling solidification, the length from the discharge slit of the T-shaped die to the point where the melt sheet is pressed by the metal roll and cooling roll is set to 50 mm or more and 250 mm or less.
